(19) United States
(12) Patent Application Publication
(10) Pub. No.: US 2017/0079083 A1
(43) Pub. Date: Mar. 16, 2017

(54) Method and Devices for Unidirectional Device-to-Device Communication

(71) Applicant: Telefonaktiebolaget LM Ericsson (publ), Stockholm (SE)

(72) Inventors: Iana Siomina, TÄBY (SE); Pontus WALLENTIN, LINKÖPING (SE)

(21) Appl. No.: 15/308,925

(22) PCT Filed: Apr. 29, 2015
(86) PCT No.: PCT/SE2015/050480

§ 371 Date: Nov. 4, 2016

Related U.S. Application Data
(60) Provisional application No. 61/988,570, filed on May 5, 2014.

(51) Int. Cl. H04W 76/02; H04W 8/24; H04W 52/38; H04W 72/04

(52) U.S. Cl. CPC H04W 76/023; H04W 72/0406; H04W 8/24; H04W 52/383

(57) ABSTRACT

There is described a method for device-to-device communication in a wireless communication network, the wireless communication network comprising at least a first node configured for device-to-device communication. The method comprises extracting, by the first node, transmission configuration information from a first unidirectional message, and configuring a second unidirectional message based on the extracted transmission configuration information. There are also disclosed corresponding nodes, program products and storage media.

### TECHNICAL FIELD

The present description pertains to methods and devices for unidirectional device-to-device communication.

### BACKGROUND

With wireless devices getting more and more ubiquitous, additional uses and communication possibilities open up. One very promising approach is device-to-device communication, which may help offloading a core network.

### SUMMARY

There is generally described a method for device-to-device communication in a wireless communication network. The wireless communication network comprises at least a first node, in particular a user equipment, configured for device-to-device communication. The method comprises extracting, by the first node, transmission configuration information from a first unidirectional message and configuring a second unidirectional message based on the extracted transmission configuration information. The method may include receiving, e.g. by the first node, the first unidirectional message. Alternatively, the method may include, transmitting, e.g., by the first node, the first unidirectional message, in particular to a second node. Configuring may generally be performed by the first node or an external node, e.g. a coordinating node, which may be provided with the transmission configuration information of the first message by the first node and/or transmission configuration information for the second message based on the extracted transmission configuration information.

The transmission configuration information may comprise configuration information regarding physical layer transmission, in particular information regarding transmission power and/or transmission mode and/or spectral band and/or frequency and/or frequency band and/or bandwidth and/or timing and/or coding.

Generally, the transmission configuration information may comprise configuration data for one or more layers, in particular at least for the physical layer. Additional layers may include, e.g. the linking layer and/or the MAC layer.

The transmission configuration information may be extracted from control channel data, in particular from data transmitted via a physical control channel.

Extracting may generally comprise reading out data included in the first unidirectional message and/or sensor data regarding the first unidirectional message and/or node characteristics and/or node settings regarding the first unidirectional message. For example, a header of the first unidirectional message may be read out when reading data included in the first unidirectional message. Sensor data may be provided by at least one sensor of the node and/or a controller connected to such at least one sensor, and in particular may relate to physical characteristics of the first unidirectional message, e.g. frequency and/or timing. Node characteristics and/or settings may be provided by the node, e.g., a controller, and/or read out from an associated register or memory storing a characteristic and/or setting. Such settings and/or characteristics may refer to the status of the node when receiving and/or transmitting the first unidirectional message, and may in particular pertain to information as outlined above.

Alternatively or additionally, a method for connectionless device-to-device communication in a wireless communication network is described. The wireless communication network comprises at least a first node configured for device-to-device communication. The method comprises linking a second message to a first message by the first node. The first and second message each may be unidirectional messages and/or messages of and/or for connectionless device-to-device communication. The method may include receiving, e.g. by the first node, the first message. Alternatively, the method may include, transmitting, e.g., by the node, the first message, in particular to a second node. Linking may comprise determining a relationship or relation between the first message and the second message.

Linking may comprise extracting and/or configuring as described herein. It may be performed by the first node and/or a linking unit and/or configuration unit and/or setting unit of the first node.

Furthermore, there is independently described a node, in particular a user equipment, for a wireless communication network, in particular a node arranged to carry out a method as described herein, the node comprising control circuitry configured to extract transmission configuration information from a first unidirectional message, the control circuitry further being configured to configure a second unidirectional message based on the extracted transmission configuration information. The node may comprise a correspondingly adapted extracting unit and/or configuration and/or setting unit. The node may be any of the first nodes as described herein.

It may be considered that a node is a user equipment or a base station for a wireless communication network.

The transmission configuration information may comprise configuration information regarding physical layer transmission, in particular information regarding transmission power and/or transmission mode and/or spectral band and/or frequency and/or frequency band and/or bandwidth and/or timing and/or coding.

Generally, the transmission configuration information may comprise configuration data for one or more layers, in particular at least for the physical layer. Additional layers may include, e.g. the linking layer and/or the MAC layer.

The node may be configured to extract transmission configuration information from control channel data, in particular from data transmitted via a physical control channel. The data transmitted via a physical control channel may represent at least part of a first message received by the first node.

The node may generally be configured to read data included in the first unidirectional message and/or sensor data regarding the first unidirectional message and/or node characteristics and/or node settings regarding the first unidirectional message.

Moreover, there is independently described a node, in particular a user equipment, for connectionless device-to-device communication in a wireless communication network, the node being configured to link a second message to a first message. The first and second messages each may be unidirectional messages. The node may be arranged to determine a relationship or relation between the first message and the second message to link the second message to the first message.

The node may further be configured to extract transmission configuration information from the first message and/or to configure the second message based on the extracted transmission configuration information to link the second message to the first message.

The node may generally be configured to perform one of the methods as described herein.

Moreover, the node may be further adapted to correspond to one of the first nodes described herein.

As an alternative or addition, there is also described a node, in particular a user equipment, for a wireless communication network, the node comprising control circuitry including an extraction unit configured to extract transmission configuration information from a first unidirectional message and an configuration and/or setting unit configured to configure a second unidirectional message based on the extracted transmission configuration information.

The node may be configured to perform a method as described herein.

There is also independently described a wireless communication network arrangement comprising a node as described herein and/or being configured to perform a method as described herein. The arrangement may comprise at least two nodes configured for device-to-device communication with each other. A coordinating node and/or base station may be comprised in the arrangement.

There is also described a storage medium storing code executable by a controller, the code, when executed by the controller, causing the controller to perform and/or control a method as described herein.

Moreover, there is described a controller-executable program product, the program product, when executed by the controller, causing the controller to perform and/or control a method as described herein.

The controller executing the program product and/or the code stored on the storage medium may be part of control circuitry of one of the nodes described herein, in particular it may be part of a user equipment.

There is also described a coordinating node for device-to-device communication in a wireless communication network, the coordinating mode being configured to receive, from a first node of the wireless communication network, transmission configuration information regarding a first or second message, and to provide, in particular to the first and/or a second node, a transmission configuration for the second message based on the transmission configuration information received from the first node. Moreover, there is described a method for coordinating connectionless device-to-device communication in a wireless communication network, comprising receiving, from a first node of the wireless communication network, transmission configuration information regarding a first or second message, and providing, in particular to the first node and/or a second node, a transmission configuration for second message based on the transmission configuration information received from the first node. The method may be performed by a coordinating node. The first node may be any one of the first nodes or nodes described herein.

Thus, the coordinating node may be configured to configure the transmission configuration for a second message for the node providing it with the transmission configuration information and/or for a separate second node, which may be linked to the first node. The first message may be a unidirectional message. The second message may be a unidirectional message. The first message may be already received and/or transmitted by the first node, whereas it may be considered that the second message yet has to be configured for transmission. For both the coordinating node and the method for coordinating the general remarks in the specification fully apply. The coordinating node may comprise a receiver unit, which may be part of radio circuitry and/or control circuitry, for receiving, from a first node of the wireless communication network, transmission configuration information regarding the first or second message, and a transmission unit to provide, to the first node and/or a second node, in particular to a first user equipment and/or second user equipment, a transmission configuration for the second message based on the transmission configuration information received from the first node. The coordinating node may comprise a determination unit, in particular as part of control circuitry, configured to determine, based on the transmission configuration information received from the first node, a transmission configuration for the second message, wherein the determined transmission configuration for the second message may be provided or providable to the first and/or second node via the transmission unit.

Generally, a first node or node or coordinating node as described herein may comprise radio circuitry and/or control circuitry and/or antenna circuitry. In particular, the first node or node as described herein may comprise, as control circuitry, a controller connected to a memory storing instructions executable by and/or readable by and/or accessible for the controller to carry out one of the methods and/or method steps described herein. A controller as described herein may generally be implemented as part of a node or first node, in particular a user equipment, as described herein and/or be connected to radio circuitry and/or antenna circuitry and/or a wireless interface configured to receive and/or transmit an unidirectional message from or to a second node of the wireless communication network. The wireless communication network may comprise a second node and/or a third node, in particular a second user equipment and/or a third user equipment. The second equipment may be transmitting the first unidirectional message or first message or may be the intended target of the message and/or receiving the message. It may be considered that the second message and/or second unidirectional message is configured to be received by and/or transmitted to the second node.

Providing transmission configuration information or a transmission configuration may from one node to another node may generally comprise transmitting corresponding signals and/or data from the providing node to the other node.

The first message generally may be a or the first unidirectional message. The second message generally may be a or the second unidirectional message. The methods described herein may generally comprise transmitting the second message, e.g. by the first node and/or utilizing radio and/or antenna circuitry of the first node, in particular controlled by control circuitry of the first node. The second message may be transmitted to a second node or a third node. A second node may be a node from which the first message was received. A third node may be different from the second node. The first node may generally be configured to configure and/or link the second message for transmission to the second node and/or the third node and/or to transmit the second message to the second node and/or third node.

The first node or a node or coordinating node generally may be configured to control and/or set transmission power for the second message based on the transmission configuration of the first message, in particular if it is determined by the first node that a transmission power lower than the maximum or reference transmission power is sufficient for successfully transmitting the message. The node or first node may be configured to determine whether a lower transmission power than the maximum or reference transmission power and/or which transmission power lower than the maximum or reference transmission power is sufficient for communication based on the transmission configuration of the first message. It may be considered that the transmission configuration of the first message includes information indicating the transmission power of the first message, in particular if it was transmitted by a second node. Any one of the nodes described herein, in particular a first node, may be configured to extract information regarding the transmission power as part of the transmission configuration of a first message and to compare it with a received power, e.g. based on sensor information read out from a sensor. The node may be configured to determine, based on the comparison, whether and/or which transmission power lower than the maximum or reference transmission power for the second message is to be configured and/or to configure a corresponding power. Generally, the corresponding node may determine, based on the transmission power indicated by the transmission configuration of the first message, which transmission power to configure for the second message and/or to configure and/or link the second message correspondingly, e.g. by controlling and/or setting the transmission power and/or configuration accordingly.

Configuring and/or linking the second message and/or the transmission configuration of the second message may generally comprise setting and/or controlling the transmission configuration of the second message, in particular for at least partly the physical layer and/or more than one layer. Setting and/or controlling the transmission configuration may be performed by the first node and/or in combination with an external node, e.g. a coordinating node. The transmission configuration thusly controlled and/or set may comprise one or more of transmission power and/or transmission mode and/or spectral band and/or frequency and/or frequency band and/or bandwidth and/or timing and/or coding. The first node may be configured to configure and/or link the second message, in particular to control and/or set the transmission configuration of the second message.

The first node may comprise a corresponding configuration and/or setting unit.

Alternatively or additionally, configuring and/or linking the second message and/or the transmission configuration of the second message may include providing transmission configuration information for the second message to a coordinating node, e.g. an eNodeB. The transmission configuration information may be based on the transmission configuration information of the first message. It may be considered that the transmission configuration information of the second message provided to the coordinating node may indicate a preferred transmission configuration. The first node or node may be configured to transmit the transmission configuration information of the second message to the coordinating node and/or to receive a transmission configuration for the second message from the coordinating node, in particular as a response.

The received transmission configuration may be based on the transmission configuration information transmitted to the coordinating mode. The coordinating node may be configured to receive, from a first node of the wireless communication network, transmission configuration information regarding a second message as outlined herein, and to provide, to the first node, a transmission configuration for the second message based on the transmission configuration information received from the first node. The coordinating node may be configured to determine a transmission configuration for the second message taking into account whether the transmission configuration information provided by the first node is suitable e.g. considering network conditions, and may be configured to indicate that the transmission configuration information may be used to configure the second message and/or to amend the transmission configuration for the second message before transmitting it to the first node.

The transmission configuration for the second message may be configured and/or linked for the second node, which may be the node from which the first message was received by the first node, and/or the first node may be configured to configure and/or link the second message and/or second unidirectional message accordingly. Accordingly, the second message may be intended for the node transmitting the first message, e.g. the second node. It may also be considered that the first node transmitted the first message, e.g. to a second node, and re-uses the transmission configuration for a second message intended for the same target, e.g. a second node. Alternatively or additionally, the first node may be configured to configure or link the second message for transmission to a third node. In particular, the first node may be configured to configure and/or set the transmission configuration for the second message to differ from the transmission configuration information of the first message for configuring and/or linking the second message for transmission to a third node different from the second node. Correspondingly, configuring and/or linking may be performed, e.g. by the first node and/or a configuration and/or setting unit of the first node, to configure the second message for transmission to a third node. In particular, it may be considered that the transmission configuration for the second message is controlled and/or set to differ from the transmission configuration information of the first message. Thus, configuring of the second message may be performed based on the transmission configuration of the first message and/or the second message may thusly be linked to the first message.

Configuring and/or linking the transmission power of the second message and/or re-using transmission configuration information from a first message to configure a second message to be sent or transmitted to a second node and/or changing the transmission configuration of the second message for transmitting a message to a third node are some examples of cases, in which configuring and/or linking are performed based on transmission configuration information of the first message, as in these cases the transmission configuration of the second message is adapted dependent on transmission configuration information of the first message.

Individual units and/or circuits described herein may be implemented as physically separated units and/or circuits or as logically separated unit implemented on a common physical device. In particular, extracting units and/or configuration or setting units as described herein may be implemented in control circuitry and/or in one controller.

The methods and devices described therein allow easy configuration and/or linking of messages in particular in connectionless and/or unidirectional communication with minimal interaction with a coordinating node or base station. This can limit signaling overhead and improve reaction time, in particular in catastrophic scenarios.

### BRIEF DESCRIPTION OF THE DRAWINGS

FIG. 1 schematically shows a setup of a wireless communication network with device-to-device communication.

FIG. 2 schematically shows a different setup of a wireless communication network with device-to-device communication.

FIG. 3 schematically shows yet another different setup of a wireless communication network with device-to-device communication.

FIG. 4 schematically shows a setup for device-to-device communication in a wireless communication network in greater detail.

FIG. 5 schematically shows a user equipment.

FIG. 6 schematically shows a base station.

FIGS. 7 and 8 and show methods for device-to-device communication in schematic flowcharts.

### DETAILED DESCRIPTION

In the context of this description, wireless communication may be communication, in particular transmission and/or reception of data, via electromagnetic waves, in particular radio waves, e.g. utilizing a radio access technology (RAT). The communication may be between nodes of a wireless communication network. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes of the communication. It may, e.g., include address data referring to a node of the communication and/or data pertaining to the transmission mode and/or spectral configuration and/or frequency and/or coding and/or timing and/or bandwidth as data pertaining to the process of communication or transmission, e.g. in a header. Each node involved in communication may comprise radio circuitry and/or control circuitry and/or antenna circuitry, which may be arranged to utilize and/or implement one or more than one radio access technologies.

Radio circuitry of a node may generally be adapted for the transmission and/or reception of radio waves, and in particular may comprise a corresponding transmitter and/or receiver and/or transceiver, which may be connected or connectable to antenna circuitry and/or control circuitry. Control circuitry of a node may comprise a controller and/or memory arranged to be accessible for the controller for read and/or write access. The controller may be arranged to control the communication and/or the radio circuitry and/or provide additional services. Circuitry of a node, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered. A node of a wireless communication network may be implemented as a user equipment and/or base station and/or relay node.

A wireless communication network may comprise at least one of a device configured for device-to-device communication and/or a user equipment and/or base station and/or relay node, in particular at least one user equipment, which may be arranged for device-to-device communication with a second node of the wireless communication network, in particular with a second user equipment. A node may comprise at least one sensor to detect and/or sense at least parts of the transmission configuration of a message, in particular of a received message, e.g. the received power. It may be considered that a node comprises one or more status indicating devices indicating a node status, in particular node characteristics and/or node settings, defining at least parts of a transmission configuration of a transmitted and/or received message, e.g. memory and/or registers and/or switches configured to store and/or define at least parts of a transmission configuration of a transmitted and/or received message. Control circuitry and/or a controller may be connected and/or connectable to at least one status indicating device and/or may be adapted to read transmission configuration information from the at least one status indicating device. A node of or for a wireless communication network may generally be a wireless device configured for wireless device-to-device communication. Device-to-device communication may optionally include broadcast and/or multicast communication to a plurality of devices or nodes.

A user equipment (UE) may generally be a device configured for wireless device-to-device communication and/or a terminal for a wireless and/or cellular network, in particular a mobile terminal, for example a mobile phone, smart phone, tablet, PDA, etc. A user equipment may generally be proximity services (ProSe) enabled. It may be considered that a user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A node or device of or for a wireless communication network, in particular a node or device for device-to-device communication, may generally be a user equipment. It may be considered that a user equipment is configured to be a user equipment adapted for LTE/E-UTRAN.

A base station may be any kind of base station of a wireless and/or cellular network adapted to serve one or more user equipments. A base station may be adapted to provide and/or define one or more cells of the network. It may be considered that a base station comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in device-to-device communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station. An eNodeB may be envisioned as a base station. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations. A base station may be considered to be a node of a wireless communication network. Generally, a base station may be considered to be configured to be a coordinating node in particular for device-to-device communication between two nodes of a wireless communication network, in particular two user equipments.

Device-to-device (D2D) communication may generally refer to communication between nodes of a wireless communication network, in particular wireless nodes. The communication may be wireless communication. A device in this context may be a node of the wireless communication network, in particular a user equipment or a base station. Device-to-device communication may in particular be communication involving at least one user equipment, e.g. between two or more user equipments. Device-to-device communication may be relayed and/or provided via a base station or coordinating node or relay node or be direct communication between two devices, e.g. user equipments, without involvement of a base station or coordinating node and/or with a base station or coordinating node providing merely auxiliary services, e.g. configuration data or a transmission configuration or related information for a message intended for device-to-device communication between user equipments. In the latter case, it may be considered that data and/or signals flowing between the nodes performing device-to-device communication are not transported via the base station and/or coordinating node. During device-to-device communication, a message may be provided and/or transmitted and/or received. A message may be considered to be or be represented by a batch of physical layer transmissions and/or may comprise such. A message may comprise information regarding the transmission configuration, in particular regarding related information, e.g. in a header, and/or a payload. A unidirectional message may be a message for connectionless communication and/or for which no prior communication and/or prior connection between the transmitting node and receiving node is necessary and/or available and/or for which no response or no response protocol or no handshake is expected. A device configured for device-to-device communication may comprise control circuitry and/or radio circuitry configured to provide device-to-device communication, in particular configured to enable proximity services (ProSe-enabled), e.g., according to LTE/E-UTRAN requirements.

A transmission configuration of a message may generally refer to and/or define at least a part of physical layer characteristics and/or settings for transmission of the message. The configuration may for example refer to physical resources used and/or transmission power and/or transmission mode and/or spectral band and/or frequency and/or frequency band and/or bandwidth and/or timing and/or coding and/or address information, e.g. source address and/or target address information. Address information may by way of example include IP address, network address, MAC address, etc. Additional layers referred to by the transmission configuration may include, e.g. the link layer and/or the MAC (Medium Access Control) layer. Transmission configuration information may refer to information regarding a transmission configuration and/or at least part of a transmission configuration. A node may generally be configured to include transmission configuration information of a message transmitted by the node into a message, in particular information indicating the transmission power with which the message is transmitted by the transmitting node. Transmission configuration information may generally be included in transmission data, e.g. in a header, in particular as address data, and/or extracted from such data and/or related data, e.g. from sensor data or node status information. For a message intended for sending or transmission, a configuration for transmission may correspond to the intended transmission configuration.

In connectionless device-to-device communication, i.e., when no logical connection is established first to enable data communication, there may still be a need to link multiple physical layer (PHY) transmission sessions from the same and/or different UEs (user equipments), e.g., when
UE1 transmits in response to a received PHY transmission from UE2, or
UE1 transmits a second batch of PHY transmissions to one or more UE2 after some time from the first batch of PHY transmissions (this may or may not be in response to a received PHY transmission from UE2).

UE1 and UE2 may be considered to be nodes of a wireless communication network, wherein UE1 may correspond to a first node and UE2 to a second node. The first batch of PHY transmissions may represent a first message, and the second batch of PHY transmissions may represent a second message.

Independent transmission configurations of the first and second batches of PHY transmissions for D2D (device-to-device) are currently independent, which may result in inefficient resource utilization.

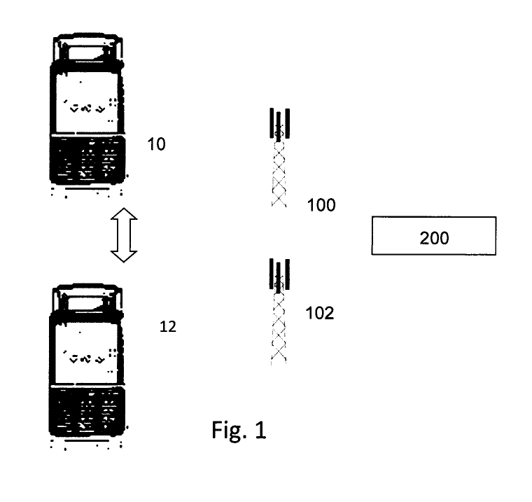

In FIGS. 1 to 3, there are shown different setups for communication of user equipments within a wireless communication network. In these figures, the first node or first user equipment UE1 is indicated with reference numeral 10, the second node or second user equipment is indicated with reference numeral 12. A first base station, which may be an eNodeB and/or EPC according to LTE/E-UTRAN, carries the reference numeral 100, whereas a second base station, which may be an eNodeB and/or EPC according to LTE/UTRAN, is referenced with numeral 102. The nodes 100, 102 may be configured as coordinating nodes for D2D communication between the UEs 10, 12. Reference numeral 200 indicates higher layer functions or devices of the network, to which the base stations 100, 102 may be connected or connectable, e.g. LTE packet core elements like SGW (Server GateWay) and/or PGW (PDN GateWay) and/or MME (Mobility Management Entity).

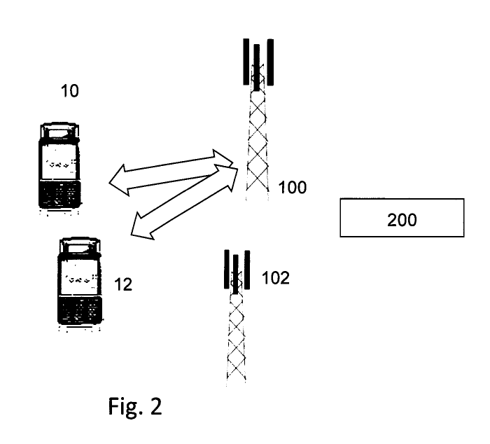

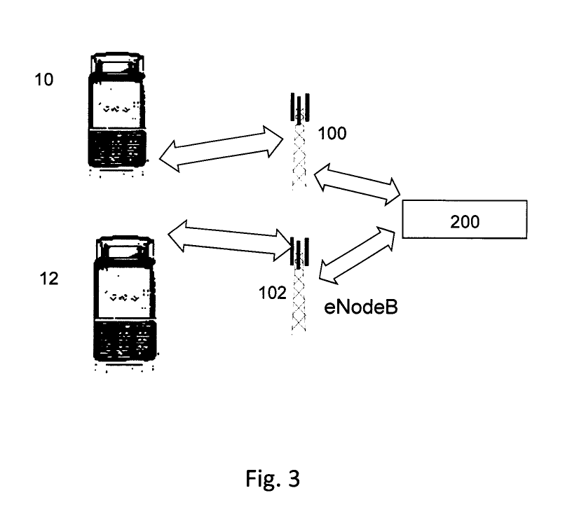

If UEs 100, 102 are in proximity to each other, they may be able to use a “direct mode” (e.g., as in FIG. 1) or “locally-routed” (e.g., as in FIG. 2) path for data communication, unlike in the conventional cellular communication (FIG. 3). In device-to-device communication, the source and the target are wireless devices, e.g., UEs. Some of the potential advantages of device-to-device communication are off-loading of the cellular network, faster communication, increased awareness of surrounding wireless devices of interest (e.g., running the same application), higher-quality links due to a shorter distance, etc. Some appealing applications of D2D communications are video streaming, online gaming, media downloading, peer-to-peer (P2P), file sharing, etc.

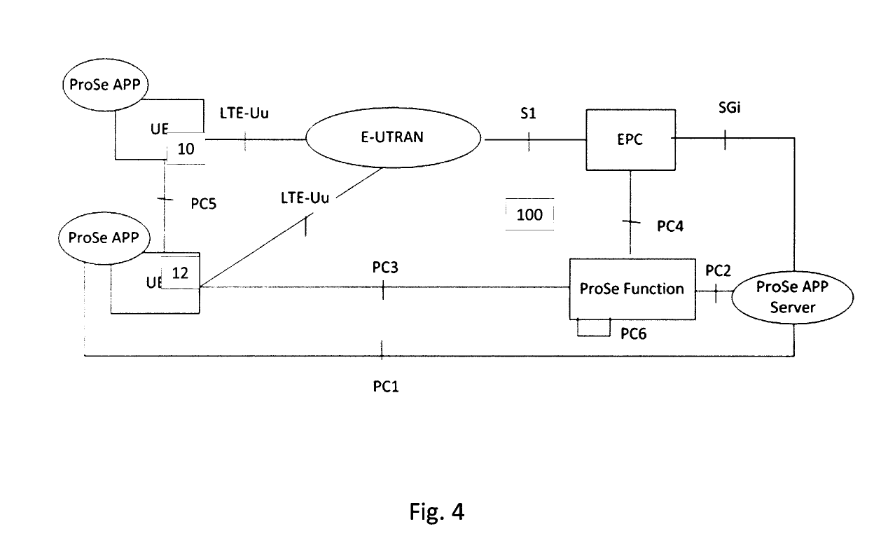

A more detailed example reference architecture for D2D operation according to one possible LTE/E-UTRAN implementation is illustrated in FIG. 4, in which only a setup with two UEs 10, 12 connected to a common base station or eNodeB 100 is shown. In FIG. 4, PCn identifies different reference points or interfaces. PC1 refers to a reference point between a ProSe application ProSe APP running on an UE 10 or 12, PC2 a reference point between an ProSe Application server and a ProSe function provider on a server or base station side. PC3 indicates a reference point between the UE 12 and the ProSE function, e.g. for discovery and/or communication. PC4 refers to a reference point between the EPC and the ProSe function, e.g. for setting up setting up one-to-one communication between UEs 10 and 12. PC5 is a reference point between UE 10 and UE 12, e.g. a first node and a second node involved in D2D communication, which may be used e.g. for direct or relayed communication between the UEs. PC6 identifies a reference point between ProSE functions of different networks, e.g. if UEs 10, 12 are subscribed to different PLMNs (Public Land Mobile Networks). SGi indicates an interface which may be used, inter alia, for application data and/or application level control. The EPC (Evolved Packet Core) may generally include a plurality of core packet functions or entities, e.g. MME, SGW, PWG, PCRF (Policy Charging and Rules Function), HSS (Home Subscriber Server), etc. E-UTRAN is the preferred RAT of the arrangement of FIG. 4. LTE-Uu indicates data transmission connections between the UEs 10, 12 and the base station 100.

Connection-oriented communication implies that a logical and a physical data channel, or connection, needs to be established first in order to enable data communication. The source and the target must be known for establishing such a connection. This communication mode is targeting primarily one-to-one (unicast) communication. Group communication may then be realized via multiple unicast links, which may cause some overhead and additional interference.

With connectionless communication, messages and/or data can be sent from one device to another device without prior arrangement, thereby reducing the overhead and increasing the communication capacity which is crucial in emergency situations. The source device, e.g. a first node, transmits data to one (unicast) or more (multicast/groupcast/broadcast) other devices or nodes, without first ensuring that the recipients are available and ready to receive the data. Connectionless communication may be used for one-to-one or one-to-many communication, but it is particularly effective for multicast and broadcast transmissions and thus well-suited for broadcast and group communication. The connectionless communication may be realized, e.g., via PHY unicast/multicast/groupcast/broadcast transmissions; with PHY broadcast transmissions, the transmissions may still be turned into unicast/groupcast/multicast at higher layers. For example, in the MAC layer, multicast or even unicast addresses may be used. Or, alternatively, if using broadcast on both PHY and MAC, multicast or unicast IP addresses may be used at the IP layer.

Examples for operation modes for D2D operation are discussed.

A D2D-capable UE may operate in two modes:

Mode 1: an eNodeB (e.g. 100, 102) or rel-10 relay node arranged as coordinating node or base station schedules the exact resources used by the UE, e.g. 10, 12, to transmit data and/or control information via a direct (D2D) link

Mode 2: the UE autonomously selects resources to be used for transmitting data and/or control information via a direct (D2D) link

The usage of a specific mode may also relate to cellular coverage, e.g., a UE which is out of cellular coverage and/or range of a base station or coordinating node may not be able to use Mode 1, but may be able to use Mode 2 if a second UE 12 is within range.

In connectionless device-to-device communication, i.e., when no logical connection established first to enable data communication, there may still be a need to link multiple physical layer (PHY) transmission batches or messages from the same and/or different UEs, e.g., when
UE1 transmits a PHY transmission in response to a received PHY transmission from UE2, or
UE1 transmits a second batch of PHY transmissions to one or more UE2 after some time from the first batch of PHY transmissions (may or may not be in response to a received PHY transmission from UE2).

It would be advantageous to be able to link messages without first establishing a physical and/or logical connection.

Furthermore, configuring separately two linked batches of PHY transmissions, e.g., configuring different time-frequency resources, configuring differently transmit power, e.g. applying power control for one and transmitting at the maximum or reference power to another one, configuring different transmission modes, etc., may lead to inefficient resource utilization, signaling overhead, etc.

There are described the following examples of D2D communication and corresponding nodes:

There is described a method in a wireless device (UE1, 10) utilizing the linking at least two batches of physical-layer (PHY) transmissions or message, the method comprising the steps of:
receiving a first batch of PHY transmissions or message from a second wireless device (UE2, 12),
In response to the first batch of PHY transmissions or first message, transmitting a second batch of PHY transmissions or second message from UE2 to at least the UE1, wherein the second batch of PHY transmissions or second message is linked, e.g. by UE 1, with the first batch of PHY transmissions or first message.

In one further embodiment, the transmitting further comprises applying (e.g., comprising configuring by UE1 or comprising applying in UE1 a configuration configured by its serving eNodeB, e.g. node 100) a configuration of the second batch of PHY transmissions from the UE1, which is based at least on the transmission configuration of the first batch of PHY transmissions from the UE2.

Further there is described a method in a wireless device or first node utilizing the linking at least two batches of physical-layer (PHY) transmissions, the method comprising the steps of:
Transmitting a first batch of PHY transmissions or a first message from the wireless device or first node to at least one other wireless device or a second node,
Transmitting a second batch of PHY transmissions or a second message from the wireless device or first node to the at least one other wireless device or second node, wherein the second batch of PHY transmissions or second message is linked with the first batch of PHY transmissions or first message.

In one further embodiment, the transmitting further comprises applying a configuration of the second batch of PHY transmissions or second message from the wireless device or first node, which is based at least on the transmission configuration of the first batch of PHY transmissions or first message from the same wireless device, transmitted earlier in time.

A method of configuring a second D2D-related transmission based on a linked D2D-related transmission configuration is also described.

Some generalizations are introduced in the following.

Device-to-device (D2D): In some examples, the terms ‘D2D’ and ‘proximity service’ (ProSe) and even ‘peer-to-peer communication’ may be used interchangeably. D2D UE or D2D device or interchangeably called UE or even D2D-capable UE in some embodiments herein, may comprise any entity capable of at least receiving or transmitting radio signals on a direct radio link, i.e., between this entity and another D2D capable entity. A D2D-capable device may also be comprised in a cellular UE, PDA, a wireless device, laptop, mobile, sensor, relay, D2D relay, or even a small base station employing a UE-like interface, etc. A D2D-capable is able to support at least one D2D operation.

D2D operation may comprise any action or activity related to D2D, e.g., transmitting or receiving a signal/channel type for D2D purpose, transmitting or receiving data by means of D2D communication, transmitting or receiving control or assistance data for D2D purpose, transmitting or receiving a request for control or assistance data for D2D, selecting a D2D operation mode, initiating/starting D2D operation, switching to D2D operation mode from a cellular operation mode, configuring receiver or transmitter with one or more parameters for D2D. D2D operation may be for a commercial purpose or to support public safety, using the data related to D2D. D2D operation may or may not be specific to a certain D2D service.

Cellular operation (by UE) may comprise any action or activity related to cellular network (any one or more RATs). Some examples of cellular operation may be a radio signal transmission, a radio signal reception, performing a radio measurement, performing a mobility operation or RRM related to cellular network.

D2D transmission is any transmission by a D2D device. Some examples of D2D transmission are physical signals or physical channels, dedicated or common/shared, e.g., reference signal, synchronization signal, control channel, data channel, broadcast channel, paging channel, etc. A D2D transmission on a direct radio link is intended for receiving by another D2D device. A D2D transmission may be a unicast, groupcast, or broadcast transmission. A D2D transmission may be on the uplink time-frequency resources of a wireless communication system.

A coordinating node: a node that may schedule, decide, at least in part, or select time-frequency resources and/or physical layer resources or characteristics to be used for at least one of: cellular transmissions and D2D transmissions. The coordinating node in particular may provide the scheduling information to another node such as another D2D device or node configured for device-to-device communication in a wireless communication network, a cluster head, a radio network node such as eNodeB, or a network node (e.g. a core network node). The coordinating node may communicate with a radio network node. It may be implemented in a base station.

Radio spectrum: Although at least some of the embodiments are described for D2D transmissions in the UL spectrum (FDD) or UL resources (TDD), the embodiments are not limited to the usage of UL radio resources, neither to licensed or unlicensed spectrum, or any specific spectrum at all.

A cellular network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology): e.g. LTE FDD, LTE TDD, GSM, CDMA, WCDMA, WiFi, WLAN, WiMAX, etc.

The network node may be a radio network node or another network node. Some examples of the radio network node are a radio base station, a relay node, an access point, a cluster head, RNC, etc. The radio network node may be comprised in a wireless communication network and may also support cellular operation. Some examples of a network node which is not a radio network node are: a core network node, MME, a node controlling at least in part mobility of a wireless device, SON node, O&M node, positioning node, a server, an application server, a D2D server (which may be capable of some but not all D2D-related features), a node comprising a ProSe function, a ProSe server, an external node, or a node comprised in another network.

The term configuring or linking a transmission configuration or ‘configuring a D2D-related transmission’ used herein may comprise for example configuring and/or setting one or more of:
(Re)selection and/or configuring a transmission mode of a D2D-capable wireless device (e.g., selecting between Mode 1 and Mode 2 described in Section 4.1),
Configuring time and/or frequency resources for a D2D operation (e.g., D2D data transmission, D2D control data transmission, see Section 6.1 for more examples),
Configuring transmit power for a D2D-related transmission,
Configuring periodicity of at least one D2D-related transmission,
Configuring layer 2 parameters, e.g. MAC logical channel identity, RLC sequence number size

The embodiments described herein may be combined with each other in any way.

Some methods for utilizing the linking of PHY transmissions from different wireless devices are described as follows.

According to this part of the specification, a first wireless device (UE1, 10) utilizes linking of at least two batches of physical-layer (PHY) transmissions or messages, which may be own and another wireless device's (UE2, 12) transmission, while implementing a method comprising the steps of:
Step 1: Receiving a first batch of PHY transmissions or a first message from a UE2 (12),
Step 2: In response to the first batch of PHY transmissions or first message, transmitting a second batch of PHY transmissions or second message from the UE1 (10) to at least the UE2 (12), wherein the second batch of PHY transmissions or second message is linked with the first batch of PHY transmissions.

The first and the second batched of PHY transmissions (or, hereafter the first and the second transmissions or messages) may be on the same or different carrier frequencies, in the same or different frequency bands, in the same or different RATs. The linking comprises determining the relation between the second batch of PHY transmissions and the first batch of PHY transmissions.

In one further embodiment, the transmitting further comprises applying a configuration of the second batch of PHY transmissions from or by the UE1 10, which is based at least on the transmission configuration of the first batch of PHY transmissions from the UE2 12.

The method may comprise a step of indicating to a node (e.g., eNodeB 100 serving UE1) configuring the second transmission configuration (i.e., for the second batch of PHY transmissions or second message) one or both of:
the linking information (e.g., an identity identifying the linked first transmission), and
preferred second transmission configuration, wherein the preferred second transmission configuration is based on the first transmission configuration (i.e., for the first batch of PHY transmissions or the first message).

Some methods of linking or configuring are described as follows.

UE1 10 extracts transmission configuration information related to the first transmission or message from UE2 and may store it, e.g., one or more of:
One or several addresses associated with the first transmission or message (e.g., the L1 and/or MAC and/or IP source and/or destination address of the first transmission, ProSe UE identity, etc.),
at least one parameter of the transmission configuration for the first transmission of UE1, e.g., transmission mode, time and/or frequency resource configuration, transmit power, etc.

The data may be stored, e.g., in a buffer or internal/external memory, at least within a certain time window. Extracting may be performed by control circuitry and/or a controller of UE1 10.

The second transmission or message (from UE1 10) may be triggered by higher layers, e.g., an application layer, e.g. via a transmission request. The transmission request may be further propagated to other layers below. At some layer in UE1 10, it is determined whether the second transmission or message (from UE1) is related to the first transmission (from UE2 12), which may be based, e.g., on a comparison of the destination identity of the second transmission to the identity in the stored data related to the first transmission. The determined relation/linking may further be used by the UE1 10 for configuring the second transmission from UE1 10 (if the UE1 configures) or for assisting a network node in configuring the second transmission from the UE1 (e.g., by providing to the network node the linking information or by indicating the preferred transmission configuration for the second transmission based on the linked first transmission configuration).

Some methods for utilizing the linking of two batches of PHY transmissions from the same wireless device are described as follows.

According to this aspect, a wireless device (e.g. a first node) utilizes linking of at least two batches of physical-layer (PHY) transmissions or messages, the method comprising the steps of:
Step 1: Transmitting a first batch of PHY transmissions or a first message from the wireless device (e.g. UE1 10) to at least one other wireless device (e.g. a second node like UE 2 12),
Step 2: Transmitting a second batch of PHY transmissions or a second message from the wireless device (e.g. UE1 10) to the at least one other wireless device (e.g. UE2 12), wherein the second batch of PHY transmissions or second message is linked with the first batch of PHY transmissions.

The first and the second batched of PHY transmissions (or, hereafter the first and the second transmissions or messages) may be on the same or different carrier frequencies, in the same or different frequency bands, in the same or different RATs. The linking or configuring may comprises determining the relation between the second batch of PHY transmissions and the first batch of PHY transmissions.

In one further embodiment, the transmitting further comprises applying a configuration of the second batch of PHY transmissions or second message from or by the wireless device or first node, which may be based at least on the transmission configuration of the first batch of PHY transmissions or first message from the same wireless device or the first node, which may have been transmitted earlier in time.

In another embodiment, the method may also comprise a step of indicating to a node, in particular a coordinating node (e.g., eNodeB 100 serving UE1), configuring the second transmission configuration (i.e., for the second batch of PHY transmissions or second message) one or both of:
the linking information (e.g., an identity identifying the linked first transmission) and/or transmission configuration information extracted from the first message, and
preferred second transmission configuration, wherein the preferred second transmission configuration is based on the first transmission configuration (i.e., for the first batch of PHY transmissions).

Some methods of linking are described as follows.

The wireless device may extract and/or store data or information related to its first transmission or message, in particular the transmission configuration, e.g., one or more of:
One or several addresses associated with the first transmission (e.g., the L1 and/or MAC and/or IP source and/or destination address of the first transmission, ProSe UE identity, etc.),
at least one parameter of the transmission configuration for the first transmission of UE1, e.g., transmission mode, time and/or frequency resource configuration, transmit power, etc.

The data may be stored, e.g., in a buffer or internal/external memory, at least within a certain time window.

The second transmission may be triggered by higher layers, e.g., an application layer. The transmission request is further propagated to other layers below. At some layer in the wireless device, it is determined whether the second transmission is related to the first transmission, which may be based, e.g., on a comparison of the destination identity of the second transmission to the identity in the stored data related to the first transmission.

Further, in case of VoIP communication, header compression may be used (e.g. using ROHC), which means that the IP addresses are normally not sent in every packet. However, the full IP header is typically sent in the first packet. So, when a wireless device receives a packet from with the full IP header (as a first transmission), it stores the source and destination IP addresses, together with the L1 and/or MAC source and/or destination addresses and the parameters of the transmission configuration of this first transmission (see above).

When UE1 receives further packets from UE2 (second transmission), with compressed (i.e. none) IP header, it uses the L1 and/or MAC source and/or destination addresses to link or associate this second transmission from UE2 with the first transmission from UE2.

The determined relation/linking may further be used by the wireless device for configuring its second transmission (if the wireless device configures) or for assisting a network node in configuring the second transmission (e.g., by providing to the network node the linking information or by indicating the preferred transmission configuration for the second transmission based on the linked first transmission configuration).

Some methods of configuring a second D2D-related transmission based on a linked D2D-related transmission configuration are described as follows.

According to this embodiment, a second D2D-related transmission from UE1 is configured based on the configuration of a linked first D2D-related transmission from UE2. This implies that it has also been determined that the second D2D-related transmission is linked to the first D2D-related transmission, which may be performed by UE1 or by a network node or coordinating node configuring UE1.

UE1 and UE2 may be the same or different D2D-capable wireless devices.

In one example, the second D2D-related transmission is configured in the same way as the first D2D-related transmission at least in one of the following aspects:
Transmission mode,
Time and/or frequency resources for at least one D2D operation,
Some examples of time resources: subframe, radio frame, slot, time offset with respect to a reference time,
Some examples of frequency resources: carrier frequency, bandwidth, frequency position
Transmit power for at least one D2D-related transmission,
Periodicity of at least one D2D-related transmission,
Configuring layer 2 parameters, e.g. MAC logical channel identity, RLC sequence number size

The configuring may performed by the UE1, which obtains the transmission configuration of the first D2D-related transmission.

The configuring of the second D2D-related transmission may also be by a network node, e.g., the serving node or coordinating node of UE1, which may obtain or receive the explicit or implicit (e.g., preferred or comprised in the other data) transmission configuration of the first D2D-related transmission of UE1, which may be transmitted by UE1.

A situation in which the first and second transmissions are from different wireless devices is described as follows.

In one embodiment, the first and the second transmissions or messages are from different wireless devices, i.e., UE1 and UE2 are different wireless devices. In this case, the obtaining (by UE1 or by a network or coordinating node) of the transmission configuration of the first D2D-related transmission of UE2 may be, e.g., by one or more of:
Receiving the transmission configuration of the first message and/or preferred transmission configuration for the second message via explicit or implicit signaling from another node (e.g., from UE1, from a relaying wireless device, from a network or coordinating node controlling or coordinating one or both of UE1 and UE2, from a relaying network node)
In one example, the signaling may comprise or may be indicative of at least one of: transmission mode, time and/or frequency resources for at least one D2D operation, transmit power for at least one D2D-related transmission, periodicity of at least one D2D-related transmission,
When the signaling is received from a network or coordinating node, the first D2D-related transmission configuration may be either
received by the network node from UE1 (and thus correspondingly signaled by UE1 to the network node), or
configured by the network node, or
may be comprised in a preferred transmission configuration signaled by UE1 to the network node (which then in response configures UE1)
When the signaling is received from UE2, the UE2 may in turn either receive the first D2D-related transmission configuration from another node (e.g., a network or coordinating node or another wireless device) or configured by UE2 autonomously
Based on radio measurements or spectrum sensing
Based on determining whether UE2 is within cellular network coverage/partial coverage (e.g., DL-only coverage)/out of the network coverage

A situation in which the first and second transmissions are from the same wireless device is described.

In another embodiment, the first and the second transmissions are from the same wireless device, i.e., UE1 and UE2 are the same wireless devices.

In this case, the obtaining (by the wireless device or a network node) of the transmission configuration of the first D2D-related transmission may be, e.g., by one or more of:
Extracting the configuration from memory based on the linking information (e.g., an identity),
Based on a pre-defined rule,
Based on determining whether the wireless device is within cellular network coverage/partial coverage (e.g., DL-only coverage)/out of the network coverage

Some example predefined rules for transmission configuration for the first and the second batches of PHY transmissions are described.

In this section, there are provided some example rules for the linked first and second batches of PHY transmissions or first and second messages.
UE1 within network coverage selects (e.g., always or preferably) transmission Mode 1 when UE2 is using transmission Mode 1.
UE1 transmits at a level lower than a reference (e.g., the reference=maximum or reference transmit power or an absolute level in dBm) if UE2 does so
UE1 transmits on the same time and/or frequency resources as UE2, while the selected time and/or frequency resource configuration is one of multiple configurations that may be selected by a UE for the same transmission type
UE1 transmits with the same periodicity as UE2, while the configured periodicity is one of multiple periodicities that may be selected by a UE for the same transmission type.

In the rules above, some additional conditions may also apply, e.g., UE1 and UE2 are in the same coverage conditions, e.g., any one or more of the below may also apply:
both UEs are within the network coverage or both within partial coverage such as DL or UL coverage,
both UEs are served by the same cell,
both UEs are within the same area.

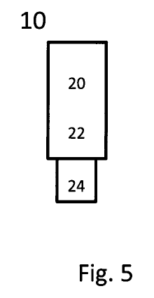

FIG. 5 schematically shows a wireless device or user equipment 10, which may be a node of a device-to-device communication, in closer details. User equipment 10 comprises control circuitry 20, which may comprise a controller connected to a memory. An extracting unit and/or configuring and/or setting unit and/or a linking unit may be implemented in the control circuitry 20, in particular as module in the controller. The user equipment also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for device-to-device communication, in particular utilizing E-UTRAN/LTE resources as described herein.

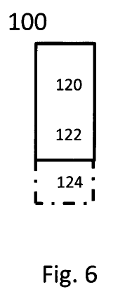

FIG. 6 schematically show a base station 100, which in particular may be an eNodeB. Base station 100 comprises control circuitry 120, which may comprise a controller connected to a memory. A configuring unit and/or a determination unit may be comprised in the control circuitry, the latter in particular if the base station is configured as a coordinating node. The control circuitry is connected to control radio circuitry 122 of the base station 100, which provides receiver and transmitter and/or transceiver functionality. It may be considered that control circuitry 120 comprises an extracting unit as described herein, in particular if the base station is configured to participate as a device in D2D communication. An antenna circuitry 124 may be connected or connectable to radio circuitry 122 to provide good signal reception or transmittance and/or amplification.

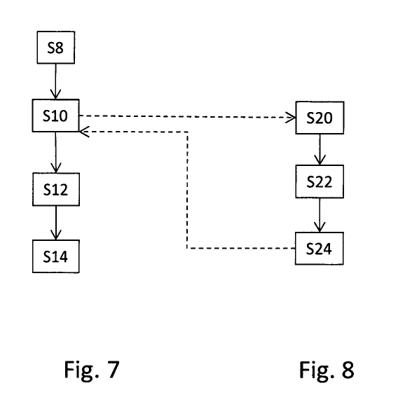

FIG. 7 schematically shows a flow diagram of a method for D2D communication. In S10, a first node for device-to-device communication in a wireless network, e.g. a user equipment 10 or base station 100, extracts transmission configuration information from a first message, which may have been received by the first node from another, second node, or transmitted by the first node itself. Alternatively, the first node may link the second message to the first message and provide information regarding the relationship between the messages. In this case, any further steps may be optional. In particular, in S12 linking information may be optionally transmitted to an external node (see below S20).

Optionally, in S8, the first node may have received the first message from a second node or itself have transmitted the first message to a second node.

In S12, a transmission configuration of a second message may be configured based on the transmission configuration information extracted from or linked to the first message. Configuring may be performed by the node intended to transmit the second message, which may be the first node or a further node. If the first node is the node intended to transmit the second message, configuring may be performed directly by the first node.

Alternatively, or if the node intended to transmit the second node is a node differently from the first node, configuring may be performed utilizing an external node, e.g. a coordinating node. In this case, the first node may transmit the transmission configuration information extracted from or linked to the first message and/or a transmission configuration of a second message based on the transmission configuration information extracted from or linked to the first message to the external or coordinating node, as indicated by the dashed lines between FIGS. 7 and 8. A transmission configuration for the second message may be configured in S12 by the node intended to transmit the second message, e.g. the first node or a further node, after receiving a corresponding transmission configuration for the second message from the external or coordinating node.

The external or coordinating node, in S20 of FIG. 8, may receive the information or data transmitted by the first node. As shown in S22 of FIG. 8, the external node may determine and/or configure a transmission configuration for the second message based on the information received, in particular based on the transmission configuration information extracted from or linked to the first message by the first node and/or the transmission configuration for the second message provided by the first node based on the transmission configuration information extracted from or linked to the first message.

The external or coordinating node in S24 may optionally transmit the determined or configured transmission configuration for the second message of S22 to the node intended to transmit the second message, for example the first node or a further node different from the first node and the external or coordinating node or may itself be the node intended to transmit the second message.

In S14 of FIG. 7, after configuring in S12 either directly or using S20 to S24 of FIG. 8, the second message may be optionally transmitted, by the node intended to transmit the second message, using the configured transmission configuration.

There are generally described:

A. Method for device-to-device communication in a wireless communication network,

the wireless communication network comprising at least a first node, in particular a user equipment, configured for device-to-device communication; the method comprising:
extracting, by the first node, transmission configuration information from a first unidirectional message; and
configuring a second unidirectional message based on the extracted transmission configuration information.

B. Method according to A, wherein the transmission configuration information comprises configuration information regarding at least physical layer transmission, in particular information regarding transmission power, transmission mode and/or spectral band and/or frequency and/or frequency band and/or bandwidth and/or timing and/or coding.

C. Method according to one of A to B, wherein the transmission configuration information comprises configuration data for one or more layers, e.g. physical layer and/or link layer and/or MAC layer.

D. Method according to one of A to C, wherein the transmission configuration information is extracted from control channel data, in particular from data transmitted via a physical control channel.

E. Method according to one of A to D, wherein extracting comprises reading out data included in the first unidirectional message and/or sensor data regarding the first unidirectional message and/or node characteristics and/or node settings regarding the first unidirectional message.

F. Method for connectionless device-to-device communication in a wireless communication network, the wireless communication network comprising at least a first node configured for device-to-device communication, the method comprising linking a second message to a first message by the first node.

G. Method according to F, wherein the linking comprises extracting and/or configuring according to one of A to E.

H. Node, in particular a user equipment, for a wireless communication network, in particular a node arranged to carry out a method as described herein, e.g., a method of one of A to F, the node comprising control circuitry configured to extract transmission configuration information from a first unidirectional message, the control circuitry further being configured to configure a second unidirectional message based on the extracted transmission configuration information and/or to link it to the first message.

I. Node according to H, the node being a user equipment or a base station for a wireless communication network.

J. Node according to one of H to I, wherein the transmission configuration information comprises configuration information regarding at least physical layer transmission, in particular information regarding transmission power and/or transmission mode and/or spectral band and/or frequency and/or frequency band and/or bandwidth and/or timing and/or coding.

K. Node according to one of H to J, wherein the transmission configuration information comprises configuration data for one or more transmission layers, e.g. physical layer and/or link layer and/or MAC layer.

L. Node according to one of H to K, wherein the node is configured to extract transmission configuration information from control channel data, in particular from data transmitted via a physical control channel, e.g., a.

M. Node according to one of H to L, wherein the node is configured to read data included in the first unidirectional message and/or sensor data regarding the first unidirectional message and/or node characteristics and/or node settings regarding the first unidirectional message.

N. Node, in particular a user equipment, for connectionless device-to-device communication in a wireless communication network, the node being configured to link a second message to a first message.

O. Node according to N, the node further being configured to extract transmission configuration information from the first unidirectional message and/or to configure the second unidirectional message based on the extracted transmission configuration information to link the second unidirectional message to the first unidirectional message.

P. Node according to N or O, the Node further being configured to perform the method as described herein, in particular the method according to one of A to G.

Q. Node according to one of N to P, the node further being adapted according to one of H to M.

R. Node, in particular a user equipment, for a wireless communication network, the Node comprising control circuitry including an extraction unit configured to extract transmission configuration information from a first unidirectional message and an configuration unit configured to configure a second unidirectional message based on the extracted transmission configuration information.

S. Node according to R, wherein the Node is configured to perform a method as described herein, in particular a method according to one of A to G, and/or is further configured according to one of H to Q.

T. Coordinating node for a wireless communication network, the coordinating mode being configured to receive, from a first node of the wireless communication network, transmission configuration information regarding a first or second message, and to provide a transmission configuration for second message based on the transmission configuration information received from the first node.

U. Method for coordinating connectionless device-to-device communication in a wireless communication network, comprising receiving, from a first node of the wireless communication network, transmission configuration information regarding a first or second message, and providing a transmission configuration for second message based on the transmission configuration information received from the first node.

V. Wireless communication network arrangement comprising a node as described herein, in particular a node according to one of H to T, and/or being configured to perform a method as described herein, in particular a method according to one of A to G or U.

W. Storage medium storing code executable by a controller, the code, when executed by the controller, causing the controller to perform and/or control a method described herein, in particular a method of one of A to G or U.

X. Controller-executable program product, the program product causing the controller to perform and/or control a method as described herein, in particular a method of one of A to G or U.

1. Method for device-to-device communication in a wireless communication network,
the wireless communication network comprising at least a first node configured for device-to-device communication; the method comprising:
extracting, by the first node, transmission configuration information from a first unidirectional message; and
configuring a second unidirectional message based on the extracted transmission configuration information.

2. Method according to claim 1, wherein the transmission configuration information comprises configuration information regarding at least physical layer transmission, in particular information regarding transmission power, transmission mode and/or spectral band and/or frequency and/or frequency band and/or bandwidth and/or timing and/or coding.

3. Method according to claim 1 wherein the transmission configuration information comprises configuration data for one or more layers, e.g. physical layer and/or link layer and/or MAC layer.

4. Method according to claim 1, wherein the transmission configuration information is extracted from control channel data, in particular from data transmitted via a physical control channel.

5. Method according to claim 1, wherein extracting comprises reading out data included in the first unidirectional message and/or sensor data regarding the first unidirectional message and/or node characteristics and/or node settings regarding the first unidirectional message.

6. Method for connectionless device-to-device communication in a wireless communication network, the wireless communication network comprising at least a first node configured for device-to-device communication, the method comprising linking a second message to a first message by the first node.

7. (canceled)

8. Node for a wireless communication network, the node comprising control circuitry configured to extract transmission configuration information from a first unidirectional message, the control circuitry further being configured to configure a second unidirectional message based on the extracted transmission configuration information and/or to link it to the first message.

9. Node according to claim 8, the node being a user equipment or a base station for a wireless communication network.

10. Node according to claim 8, wherein the transmission configuration information comprises configuration information regarding at least physical layer transmission, in particular information regarding transmission power and/or transmission mode and/or spectral band and/or frequency and/or frequency band and/or bandwidth and/or timing and/or coding.

11. Node according to claim 8, wherein the transmission configuration information comprises configuration data for one or more transmission layers, e.g. physical layer and/or link layer and/or MAC layer.

12. Node according to claim 8, wherein the node is configured to extract transmission configuration information from control channel data, in particular from data transmitted via a physical control channel.

13. Node according to claim 8, wherein the node is configured to read data included in the first unidirectional message and/or sensor data regarding the first unidirectional message and/or node characteristics and/or node settings regarding the first unidirectional message.

14. Node for connectionless device-to-device communication in a wireless communication network, the node being configured to link a second message to a first message.

15. Node according to claim 14, the node further being configured to extract transmission configuration information from the first unidirectional message and/or to configure the second unidirectional message based on the extracted transmission configuration information to link the second unidirectional message to the first unidirectional message.

16. Coordinating node for a wireless communication network, the coordinating mode being configured to receive, from a first node of the wireless communication network, transmission configuration information regarding a first or second message, and to provide a transmission configuration for a second message based on the transmission configuration information received from the first node.
